(19) United States
(12) Patent Application Publication
(10) Pub. No.: US 2014/0145449 A1
(43) Pub. Date: May 29, 2014

(54) Counter Rotating Wind Generator

(71) Applicant: Carl E. Cole, Tooele, UT (US)

(72) Inventor: Carl E. Cole, Tooele, UT (US)

(21) Appl. No.: 14/090,590

(22) Filed: Nov. 26, 2013

Related U.S. Application Data
(60) Provisional application No. 61/729,838, filed on Nov. 26, 2012.

(51) Int. Cl. F03D 9/00

(52) U.S. Cl. CPC F03D 9/002
USPC 290/55

(57) ABSTRACT

A counter rotating generator apparatus for converting wind energy into electricity is disclosed. The apparatus comprises an upper turbine rotatable in a first direction and a lower turbine rotatable in the opposite direction oriented along a vertical access. The upper turbine comprises a magnetic element, and the lower turbine comprises a counter poised magnetic element. The magnetic element interacts with the counter poised magnet to counteract at least a portion of the weight of the upper turbine increasing the efficiency of the counter rotating generator apparatus. A second set of counter poised magnets near the bottom of the lower turbine shaft will also counteract at least a portion of the weight of the lower turbine.

### CROSS-REFERENCE

This application claims priority from Provisional Patent Application Ser. No. 61/729,838 filed Nov. 26, 2012.

### FIELD OF THE INVENTION

This invention pertains generally to a counter rotating generator apparatus, and more particularly to a wind generator apparatus comprising two counter rotating turbines oriented along a vertical axis for converting wind energy into electricity.

### BACKGROUND

The majority of electricity in the United States is produced by consuming fossil fuels. These energy sources are expensive to convert to electricity, difficult to obtain, and produce hazardous by-products with a significant environmental impact. While alternative power sources such as solar and water power exist, those sources may be too large, complicated, or expensive for common use. Wind energy is present almost everywhere as a viable alternative power source, especially in remote areas. Traditional windmills with propeller type configurations are commonly found in many of these areas. However, they tend to be large and aesthetically unappealing.

Consequently, there exists a need for a device designed to generate electricity in an environmentally friendly way without using fossil fuels. The present invention discloses an apparatus with a compact profile for taking advantage of the wind to produce electricity. The apparatus uses magnetic force to decrease resistance of counter rotating turbines to improve efficiency. The invention uses wind power to produce electricity without reliance on fossil fuels while maintaining an aesthetic appearance. When installed on dedicated power poles, the visual impact of the invention would be substantially minimized when compared to propeller type configurations. When installed atop existing power poles there would be minimal visual impact as the invention would be essentially in line with the power pole. If installed on a building, the invention would appear visually similar to a chimney or a vent.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a counter rotating generator apparatus for converting wind energy into electricity. The counter rotating generator apparatus comprises a first turbine which rotates in one direction, and a second turbine which rotates in an opposite direction to the first turbine. The first turbine comprises a magnetic element, and the second turbine comprises a counter poised magnetic element. The magnetic element interacts with the counter poised magnet to counteract at least a portion of the weight of the first turbine, thereby minimize resistance to rotation from friction.

Furthermore, in a preferred embodiment of the invention, the counter rotating generator apparatus is oriented along a vertical access so that the first turbine is located directly above the second turbine to reduce the profile of the apparatus. The first turbine comprises a hollow stator shaft and a plurality of rotating blades oriented in a first direction. The second turbine comprises a rotor shaft rod and a plurality of counter rotating blades oriented in a second direction essentially opposite of the direction of the plurality of rotating blades of the first turbine. The stator shaft fits over the rotor shaft rod so that first and the second turbines are coupled together. Unlike a traditional stator, the stator shaft of the apparatus is rotatable in the opposite direction of the rotor shaft rod. As wind interacts with the apparatus, the stator shaft rotates in a first direction, and the rotor shaft rod rotates in an opposite direction to essentially double the effective speed of rotation between the stator shaft and the rotor shaft rod, thereby doubling the relative velocity.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a counter rotating generator apparatus in accordance with the disclosed architecture.

FIG. 2 illustrates an exploded view of the counter rotating generator apparatus in accordance with the disclosed architecture.

FIG. 3 illustrates a perspective view of a first turbine of the counter rotating generator apparatus in accordance with the disclosed architecture.

FIG. 4 illustrates a perspective view of a second turbine of the counter rotating generator apparatus in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter. The invention relates generally to a counter rotating generator apparatus for converting wind energy into electricity.

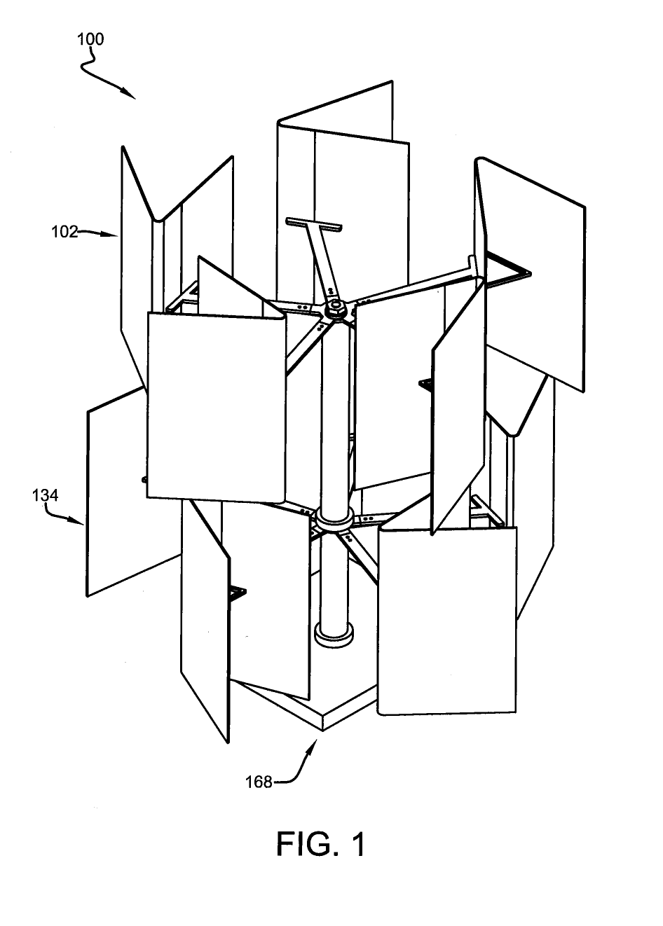

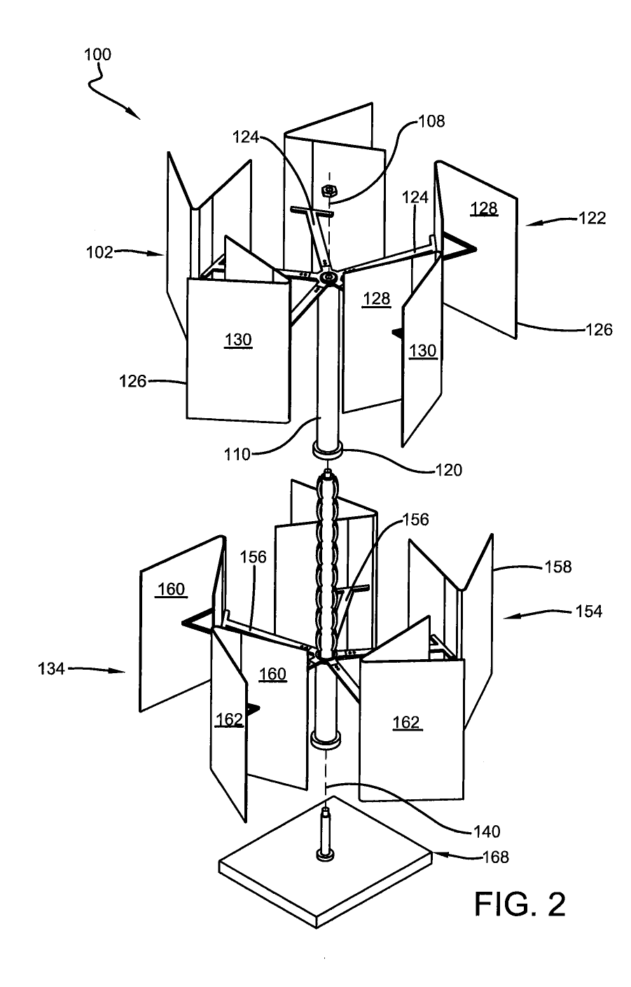

Referring initially to the drawings, FIGS. 1 and 2 illustrate a counter rotating generator apparatus 100. The counter rotating generator apparatus 100 comprises a first turbine 102, a second turbine 134, and a base 168. The first turbine 102 is oriented as to rotate in a first direction, and the second turbine 134 is oriented as to rotate in a second direction, essentially opposite the first direction, as the wind interacts with the counter rotating generator apparatus 100.

The first turbine 102 comprises a top 104, a bottom 106, and a center axis 108 preferably oriented along a vertical axis. However, the first turbine 102 can be oriented along a horizontal axis as well. In the vertical orientation, the first turbine 102 is located above the second turbine 134 along the vertical axis as described infra.

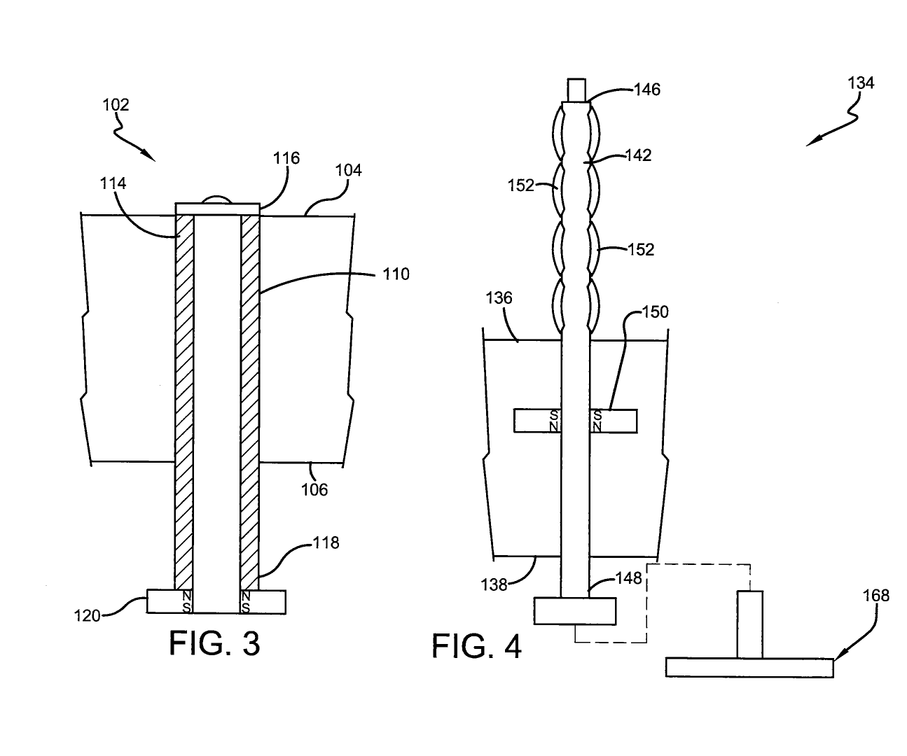

As illustrated in FIGS. 1-3, the first turbine 102 further comprises a stator shaft 110, a first blade assembly 122, and a magnetic element 120. The stator shaft 110 is a hollow tube comprising a top 116 and a base 118. The stator shaft 110 functions as a stator for the counter rotating generator apparatus 100, wherein the stator shaft further comprises a conducting field coil 114. The conducting field coil 114 is typically a copper or aluminum winding, however, this is not meant as a limitation as any material used to make a stator as is known to one of skill in the art may be substituted without affecting the overall scope of the invention. Furthermore, although the hollow tube functions as a stator, it is not stationary as it rotates when the first turbine 102 spins in the wind. The stator shaft 110 may extend the length of the first turbine 102 from the top 104 through the bottom 106 through the center axis 108. The base 118 extends past the bottom 106 of the first turbine 102.

The magnetic element 120 is attached to the base 118 of the stator shaft 110. The magnetic element 120 is typically a ring magnet or the equivalent. The ring magnet is stabilized by a housing (not shown) that is welded, bolted or heat shrink fit and keyed to the shaft. The ring magnet is typically oriented with a north pole of the ring magnet adjacent to the base 118. However, an embodiment where a south pole of the ring magnet is adjacent to the base 118 is contemplated as well.

The first blade assembly 122 comprises a plurality of blade arms 124 and a plurality of rotating blades 126. The plurality of blade arms 124 extend perpendicularly out of the stator shaft 110 and terminate in the plurality of rotating blades 126 The plurality of rotating blades 126 each comprise a windward face 128 and a leeward face 130. Each blade is typically curved, angled, or generally arcuate in shape to decrease resistance to rotation. The plurality of rotating blades 126 may be shaped in a pin-wheel configuration, a spiral, a cork-screw, a helix, and the like, or in any other shape conducive to rotating as wind engages the blades. In a preferred embodiment, the plurality of rotating blades 126 are eight in number and are a blunted arrow-shape in cross-section. This shape and number is desirable as it allows for the maximum wind energy capture with the least resistance, while decreasing any danger to wildlife such as a bird that came in accidental contact with a blade. However, additional embodiments where the plurality of blades number at least two are contemplated as well. Generally, a larger embodiment of the counter rotating generator apparatus 100 will have a greater number of blades than a smaller embodiment. For example, in a large version of the counter rotating generator apparatus 100 for industrial use, the plurality of rotating blades 126 may number fifty or more. The blunted arrow-shape is essentially a V-shape where the windward face 128 comprises an acute angle for capturing the wind, and the leeward face 130 cuts through the air with minimal resistance.

As illustrated in FIGS. 1, 2, and 4, the second turbine 134 comprises a top 136, a bottom 138, and a center axis 140 preferably oriented along the same vertical axis of the first turbine 102, as described supra. The second turbine 134 further comprises a rotor shaft 142, a second blade assembly 154, and a counter poised magnet 150. The rotor shaft 142 is a rod comprising a rod top 146 and a rod base 148. The rotor shaft 142 functions as a rotor for the counter rotating generator apparatus 100. The stator shaft 110 fits over and substantially encapsulates a portion of the rotor shaft 142 when the first turbine 102 is coupled to the second turbine 134.

The rotor shaft 142 further comprises a plurality of rotor magnets 152. The plurality of rotor magnets 152 are typically neodymium or magnets attached to the rotor rod for interacting with the conducting field coil 114 of the stator shaft 110, however any other magnet type used for rotors as is known in the art may be used as well. As wind rotates the second turbine 134, the rotor shaft 142 rotates within the stator shaft 110. This rotation allows the plurality of rotor magnets 152 to interact with the conducting field coil 114 to induce an electrical current. Additionally, the rotation of the stator shaft 110 around the rotor shaft 142 similarly induces an electrical current.

The second blade assembly 154 comprises a plurality of second blade arms 156 and a plurality of counter rotating blades 158. The plurality of second blade arms 156 extend perpendicularly out of the rotor shaft 142 and terminate in the plurality of counter rotating blades 156. The plurality of counter rotating blades 156 each comprise a windward face 160 and a leeward face 162. Essentially, the plurality of counter rotating blades 156 are identical in shape, size, and number; but are mirror imaged in configuration to the plurality of rotating blades 126 of the first turbine 102 as described supra.

The counter poised magnet 152 is attached to the rotor shaft 142 at a level above where the plurality of second blade arms 156 extend out of the rotor shaft 142. The counterpoised magnet 152 is a ring magnet like the magnetic element 120 of the first turbine 102 that is attached to the rotor shaft 142 at a level just above where the plurality of second blade arms 156 extend perpendicularly out of the rotor shaft 142. The counter poised magnet 152 is typically oriented with a south pole facing upward toward the magnetic element 120, so that the south pole of the magnetic element 120 faces and opposes the south pole of the counter poised magnet 152, thereby essentially levitating the first turbine 102 above the second turbine 134. Alternatively, if the magnetic element 120 is oriented with the south pole adjacent to the base 118, then the counter poised magnet 152 is oriented with the north pole facing upward. Typically, a magnitude of the counter poised magnet 152 is equal to or greater than a magnitude of the magnetic element 120.

The stator shaft 110 must be long enough to substantially encapsulate enough of the rotor shaft 142 so that the first turbine 102 rotates freely above the second turbine 134 and still induces a current. Similarly the rotor shaft 142 must be long enough to engage enough of the stator shaft 110 so that the first turbine 102 rotates freely above the second turbine 134 and still induces a current. Preferably the lengths of the stator shaft 110 and the rotor shaft 142 are approximately the same; however the stator shaft 110 may be longer or shorter than the rotor shaft as well.

The base 168 of the counter rotating generator apparatus 100 engages the rod base 148 of the second turbine 134 with a bearing (not shown) allowing the second turbine 134 to rotate freely relative to the base 168 of the counter rotating generator apparatus 100. One or more similar bearings may be located between the rotor shaft 142 and the stator shaft 110 so that the first turbine 102 may rotate freely relative to the second turbine 134.

Although not shown, a second magnetic element may be located on the rod base 148 of the second turbine 134, and a second counter poised magnet may be located on the base 168 of the counter rotating generator apparatus 100. The second magnetic element and the second counter poised magnet would be arranged in a similar manner as the magnetic element 120 and the counter poised magnet 150 as described supra to essentially levitate the second turbine 134 above the base 168. The benefits of counter poised magnets comprise: spinning turbines at lower wind velocity, spinning turbines longer, decreasing friction to increase rotational speed of turbines, thereby increasing electricity production compared to a traditional propeller type of windmill.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A counter rotating generator apparatus comprising:
a first turbine for rotating in a first direction comprising a top, a bottom, a stator shaft comprising a tube and a base rotatable in the first direction extending through a center and out of the bottom of the first turbine, a first blade assembly extending out of the stator shaft terminating in a plurality of rotating blades, and a magnetic element attached to the base of the stator shaft; and
a second turbine for rotating in a second direction comprising a top, a bottom, a rotor shaft comprising a rod and a rod base rotatable in the second direction extending through a center and out of the top of the second turbine for coaxially engaging the stator shaft of the first turbine, a second blade assembly extending out of the rotor shaft terminating in a plurality of counter rotating blades, and a counter poised magnet attached to the rod for opposing the magnetic element of the stator shaft of the first turbine.

2. The counter rotating generator apparatus of claim 1, wherein the stator shaft rotates around the rotor shaft and the rotor shaft rotates within the stator shaft to produce an electrical current.

3. The counter rotating generator apparatus of claim 2, wherein the magnitude of the counter poised magnetic element of the second turbine is greater than the magnitude of the magnetic element of the first turbine.

4. The counter rotating generator apparatus of claim 2, wherein the plurality of rotating blades and the plurality of counter rotating blades are oriented in a pin-wheel configuration.

5. The counter rotating generator apparatus of claim 1, wherein the counter rotating generator apparatus is disposed along a vertical axis.

6. The counter rotating generator apparatus of claim 1, wherein the counter rotating generator apparatus is disposed along a horizontal axis.

7. A counter rotating generator apparatus for converting wind energy into electricity, the apparatus comprising:
an upper turbine for rotating in a first direction comprising a top, a bottom, a stator shaft comprising a tube and a base rotatable in the first direction extending through a center and out of the bottom of the upper turbine, an upper blade assembly extending out of the stator shaft terminating in a plurality of rotating blades, and a magnetic element attached to the base of the stator shaft; and
a lower turbine for rotating in a second direction comprising a top, a bottom, a rotor shaft comprising a rod and a rod base rotatable in the second direction extending through a center and out of the top of the lower turbine for coaxially engaging the stator shaft of the upper turbine, a lower blade assembly extending out of the rotor shaft terminating in a plurality of counter rotating blades, and a counter poised magnet attached to the rod for opposing the magnetic element of the stator shaft of the first turbine; and
wherein the stator shaft is hollow for receiving a portion of the rotor shaft that extends out of the top of the second turbine and the relative rotational movement between the stator shaft and the rotor shaft generates an electrical current.

8. The counter rotating generator apparatus of claim 7, wherein the magnitude of the counter poised magnetic element of the lower turbine is greater than the magnitude of the magnetic element of the upper turbine.

9. The counter rotating generator apparatus of claim 7, wherein the first direction of rotation is opposite the second direction of rotation.

10. The counter rotating generator apparatus of claim 7, wherein the plurality of rotating blades and the plurality of counter rotating blades are a blunted arrow-shape in cross-section.

11. The counter rotating generator apparatus of claim 7, wherein the rotor shaft comprises a plurality of arc magnets to engage the stator shaft producing an electric current when either the rotor shaft or the stator shaft rotate.

12. The counter rotating generator apparatus of claim 7, wherein the stator shaft is long enough to substantially encapsulate the rotor shaft so that the upper turbine rotates freely above the lower turbine.

13. The counter rotating generator apparatus of claim 7, wherein the rotor shaft is long enough to engage the stator shaft so that the upper turbine rotates freely above the lower turbine.

14. A counter rotating generator apparatus for converting wind energy into electricity, the apparatus comprising:
an upper turbine for rotating in a first direction about a vertical axis comprising a top, a bottom, a hollow stator shaft comprising a tube and a base rotatable in the first direction extending through a center and out of the bottom of the upper turbine, an upper blade assembly extending out of the hollow stator shaft terminating in a plurality of rotating blades each comprising a blunt arrow shape in cross-section, and a magnetic element attached to the base of the stator shaft; and
a lower turbine for rotating opposite the first direction about the vertical axis comprising a top, a bottom, a rotor shaft comprising a rod and a rod base rotatable in the second direction extending through a center and out of the top of the lower turbine for coaxially engaging the hollow stator shaft of the upper turbine, a lower blade assembly extending out of the rotor shaft terminating in a plurality of counter rotating blades each comprising a blunt arrow shape in cross-section configured in a mirror image to the plurality of rotating blades of the upper turbine, and a counter poised magnet attached to the rod for opposing the magnetic element of the stator shaft of the first turbine.

15. The counter rotating generator apparatus of claim 14, wherein the hollow stator shaft rotates around the rotor shaft and the rotor shaft rotates within the hollow stator shaft to produce an electrical current.

16. The counter rotating generator apparatus of claim 15, wherein the magnitude of the counter poised magnetic element of the lower turbine is greater than the magnitude of the magnetic element of the upper turbine.

17. The counter rotating generator apparatus of claim 16, wherein the hollow stator shaft is long enough to substantially encapsulate the rotor shaft so that the upper turbine rotates freely above the lower turbine.

18. The counter rotating generator apparatus of claim 15, wherein the rotor shaft is long enough to engage the hollow stator shaft so that the upper turbine rotates freely above the lower turbine.

19. The counter rotating generator apparatus of claim 15, wherein the hollow stator shaft is approximately equal in length to the rotor shaft.

20. The counter rotating generator apparatus of claim 15, wherein the plurality of rotating blades and the plurality of counter rotating blades each comprise eight blades.
